(19) United States
(12) Patent Application Publication
(10) Pub. No.: US 2012/0098498 A1
(43) Pub. Date: Apr. 26, 2012

(54) BATTERY PACK, SEMICONDUCTOR DEVICE, PORTABLE APPARATUS AND METHOD OF REPORTING FULL CHARGE

(76) Inventor: Takanori Asai, Tokyo (JP)

(21) Appl. No.: 13/382,181

(22) PCT Filed: Jul. 5, 2010
(86) PCT No.: PCT/JP2010/061384

§ 371 Date: Jan. 4, 2012

(30) Foreign Application Priority Data
Jul. 9, 2009 (JP) 2009-162422

(51) Int. Cl. H02J 7/00

(52) U.S. Cl. 320/134

(57) ABSTRACT

Disclosed is a battery pack including a secondary battery chargeable and dischargeable and providing a power from the secondary battery to an apparatus body that contains the battery pack, including, a residual capacity detecting unit that detects a residual capacity of the secondary battery; a full charge detecting unit that detects a full charge of the secondary battery based on the residual capacity; and a full charge reporting unit that reports that the full charge is detected to the apparatus body.

### TECHNICAL FIELD

The present invention relates to a battery pack including a secondary battery chargeable and dischargeable and providing a power from the secondary battery to an apparatus body that contains the battery pack, a semiconductor device mounted on the battery pack, a portable apparatus containing the battery pack, and a method of reporting a full charge by the portable apparatus.

### BACKGROUND ART

Recently, as the size of an electronic apparatus becomes smaller, a portable apparatus driven by a secondary battery such as a lithium ion battery or the like has been developed. For a normal portable apparatus, a screen that indicates a residual capacity of the secondary battery is shown on a display or the like, and a user charges the secondary battery at an appropriate time by checking the display. The secondary battery is charged by connecting a charging adapter to the portable apparatus.

For a portable apparatus of background art, when a charging adapter is connected, a lamp indicating it is charging is turned on. Then, when the secondary battery is fully charged, the portable apparatus turns off the lamp which was turned on to report to a user that charging is completed. The technique that a portable apparatus reports to a user the status of a secondary battery or the like is described in Patent Document 1, for example.

However, for a conventional portable apparatus, a full charge is detected when plenty of time has passed for a secondary battery to be fully charged after starting to charge the secondary battery, for example. Further, for a conventional portable apparatus, a full charge is detected when a battery voltage of a secondary battery becomes equal to or more than a predetermined value.

It means that for the conventional portable apparatus, a full charge is detected without referring to a residual capacity or the like of the secondary battery. Therefore, for the conventional portable apparatus, a charging time is set longer than is actually required in order to have the residual capacity of the secondary battery 100% at the time when the completion of charging is reported to a user. Therefore, the secondary battery is charged more than is actually required every time it is charged, causing deterioration.

### [Patent Document 1] Japanese Laid-open Patent Publication No 2003-125540

### DISCLOSURE OF THE INVENTION

The present invention is made in light of the above problems, and provides a battery pack, a semiconductor device, a portable apparatus, a method of reporting full charge, and a computer readable recording medium capable of suppressing deterioration of a secondary battery by charging.

According to an embodiment, there is provided a battery pack including a secondary battery chargeable and dischargeable and providing a power from the secondary battery to an apparatus body that contains the battery pack, including, a residual capacity detecting unit that detects a residual capacity of the secondary battery; a full charge detecting unit that detects a full charge of the secondary battery based on the residual capacity; and a full charge reporting unit that reports that the full charge is detected to the apparatus body.

According to an example of the invention, deterioration of a secondary battery by charging can be suppressed.

### BRIEF DESCRIPTION OF DRAWINGS

FIG. 1 is an explanatory view showing an example of a hardware structure of a portable apparatus of a first embodiment;

FIG. 2 is an explanatory view showing a battery pack contained in the portable apparatus;

FIG. 3 is a diagram showing a hardware structure of a monitoring IC;

FIG. 4 is an explanatory view showing a functional structure of the monitoring IC;

FIG. 5 is an explanatory view showing a functional structure of the portable apparatus of the first embodiment;

FIG. 6 is a drawing showing an example of a screen where a message indicating a completion of charging is shown; and

FIG. 7 is an explanatory view showing a portable apparatus of a second embodiment.

### DESCRIPTION OF MARKS AND NUMERALS

18 charging circuit
100, 100A portable apparatus
110 report receiving unit
120 report control unit
130 switch device
200 battery pack
210 battery unit

0220 monitoring IC
300 charging adapter

### DETAILED DESCRIPTION OF THE PREFERRED EMBODIMENTS

Embodiments of the present invention will be described below with reference to drawings.

According to the invention, a monitoring IC included in a battery pack contained in a portable apparatus monitors a residual capacity of a secondary battery and when the monitoring IC detects a full charge of the secondary battery, the monitoring IC reports that the secondary battery is fully charged to the portable apparatus. Upon receiving the report of full charge, the portable apparatus reports to a user the completion of charging.

### First Embodiment

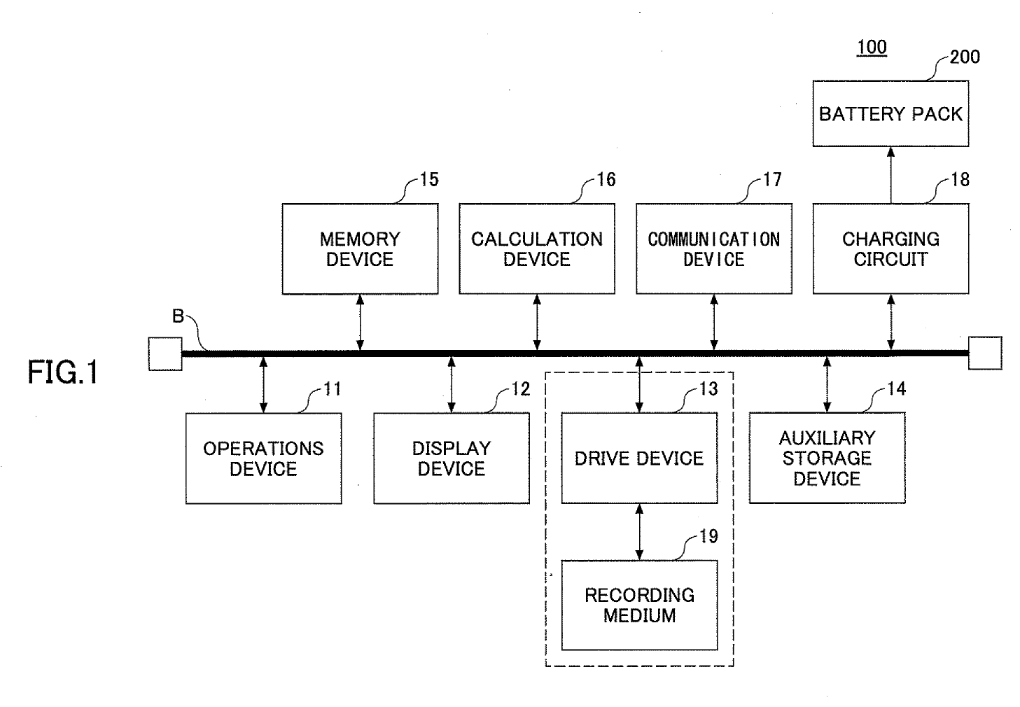

The first embodiment will be explained with reference to drawings. FIG. 1 is an explanatory view showing an example of a hardware structure of a portable apparatus of a first embodiment.

The portable apparatus 100 of the embodiment is composed of an operations device 11, a display device 12, a drive device 13, an auxiliary storage device 14, a memory device 15, a calculation device 16, a communication device 17 and a charging circuit 18 connected with each other via a bus B. The portable apparatus 100 is fed by a battery pack 200 containing a secondary battery, which will be explained later, to be driven.

The operations device 11 is for operating the portable apparatus 100 and various signals for operating the portable apparatus 100 are input. Concretely, the operations device 11 is an operational button or the like such as a power key, a ten-key or the like, for example. The display device 12 is a liquid crystal display or the like for example, and a guide screen for guiding operations of the portable apparatus 100, a progress status of processes executed in the portable apparatus 100 or the like is displayed.

The communication device 17 is a device for having the portable apparatus 100 communicate with other portable apparatus, a base station or the like. The communication device 17 is composed of an antenna or the like provided to the portable apparatus 100, for example, and performs a process for sending and receiving data by the antenna. The charging circuit 18 controls an operation of charging the secondary battery contained in the battery pack 200 when a charging adapter is connected to the portable apparatus 100.

A report program of the embodiment is at least a part of various programs for controlling the portable apparatus 100. The report program is received via the communication device 17, for example. A computer readable recording medium 19 (hereinafter simply referred to “a recording medium” as well) storing the report program is a recording medium readable by a computer (for example a memory card or the like readable by the portable apparatus 100).

Further, when the recording medium 19 storing the report program is set in the drive device 13, the report program is installed in the auxiliary storage device 14 via the drive device 13 from the recording medium 19. The report program received via the communication device 17 is installed in the auxiliary storage device 14.

The auxiliary storage device 14 includes a program storage area where various programs are stored and a data storage area where various data are stored. The installed report program or the like is stored in the program storage area. In the data storage area, necessary files, data and the like are stored. When the portable apparatus 100 is activated, the memory device 15 reads the various programs stored in the program storage area of the auxiliary storage device 14 and loads them. Then, the calculation device 16 actualizes operations, which will be explained later, in accordance with the report program developed in the memory device 15.

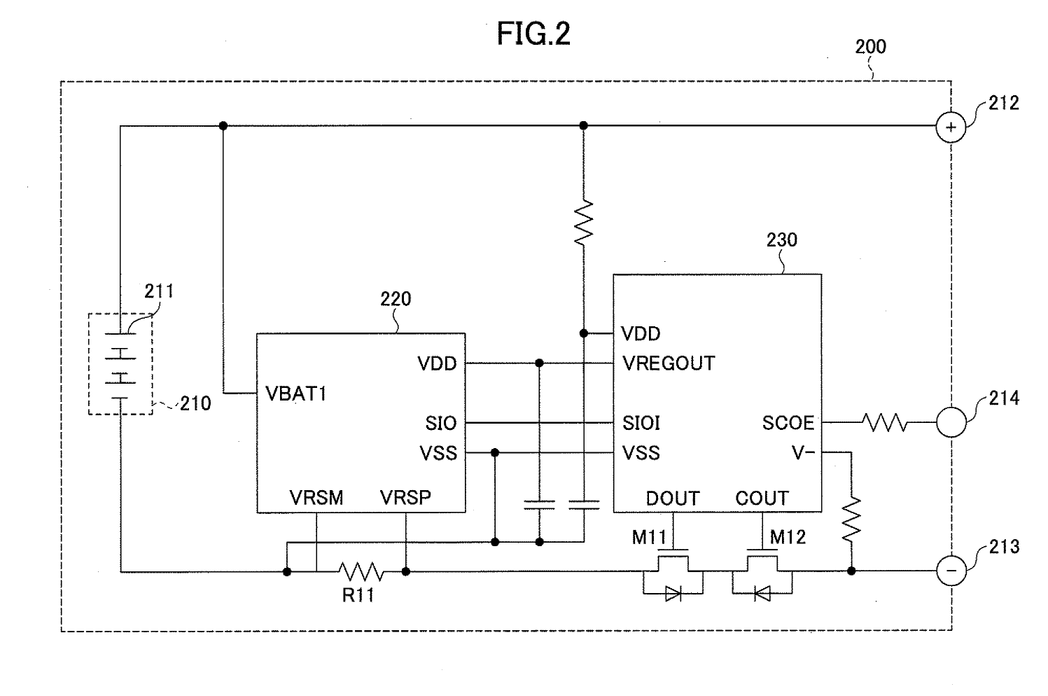

Next, the battery pack 200 contained in the portable apparatus 100 of the embodiment is explained. FIG. 2 is an explanatory view showing the battery pack contained in the portable apparatus.

The battery pack 200 of the embodiment includes a battery unit 210 in which plural secondary batteries 211 such as lithium ion batteries or the like are connected, for example. Although a structure where the battery unit 210 includes the secondary batteries 211 connected in series is shown in this embodiment, the structure of the battery unit 210 is not limited so.

The battery pack 200 includes a monitoring IC 220 and a protective IC 230 between a cathode terminal 212 and an anode terminal 213 to be connected to the portable apparatus 100 on which the battery pack 200 is mounted, and a battery unit 210.

The monitoring IC 220 monitors a status of the battery unit 210 and obtains status information of the battery unit 210. The monitoring IC 220 provides the obtained status information to the portable apparatus 100 when receiving a reference request from the portable apparatus 100.

The monitoring IC 220 includes a power supply terminal VDD, a reference electric potential terminal VSS, a voltage detection terminal VBAT1, a pair of current detection terminals VRSP and VRSM and a communication terminal SIO. The monitoring IC 220 receives a voltage regulated from a cell voltage by the protective IC 230 via the power supply terminal VDD. The reference electric potential terminal VSS is connected to an anode of the battery unit 210.

The monitoring IC 220 can detect an output voltage of the battery unit 210 via the voltage detection terminal VBAT1 connected to the cathode of the battery unit 210. One of the current detection terminals VRSM is connected to the anode of the secondary battery 211 and further connected to the other current detection terminal VRSP via an external resistance R11 located outside of the monitoring IC 220.

The monitoring IC 220 detects a current that flows through the external resistance R11, which is a charge and discharge current of the battery unit 210, via the current detection terminals VRSP and VRSM.

The communication terminal SIO is connected to an external terminal 214 which is used for a communication with the portable apparatus 100 via the protective IC 230. The monitoring IC 220 of the embodiment communicates with the portable apparatus 100 via the communication terminal SIO and the protective IC 230. The monitoring IC 220 will be explained later in detail.

The protective IC 230 protects the battery pack 200 from overcharge and overdischarge. The protective IC 230 includes a terminal DOUT and a terminal COUT respectively connected to gates of MOS transistors M11 and M12 shutting charge and discharge of the battery pack 200. The protective IC 230 switches off the MOS transistor M11 by having the output from the terminal DOUT at a low level when overdischarge or overcurrent is detected, and switches off the MOS transistor M12 by having the output from the terminal COUT at a low level when overcharge is detected in an overcharge detecting circuit.

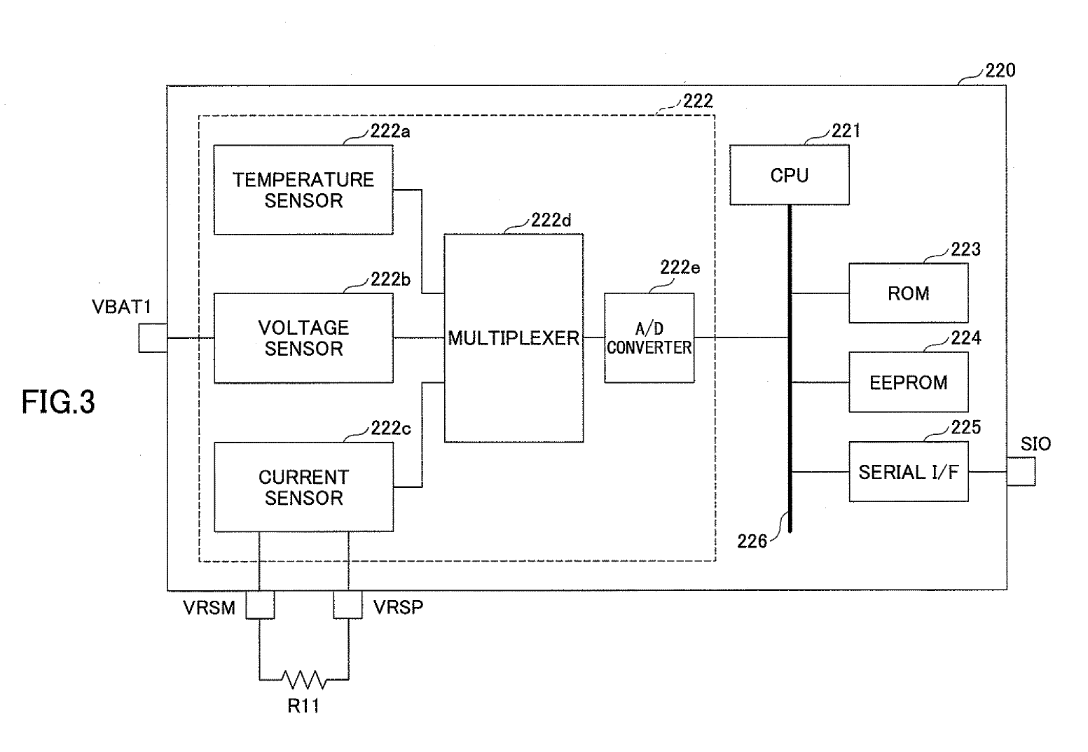

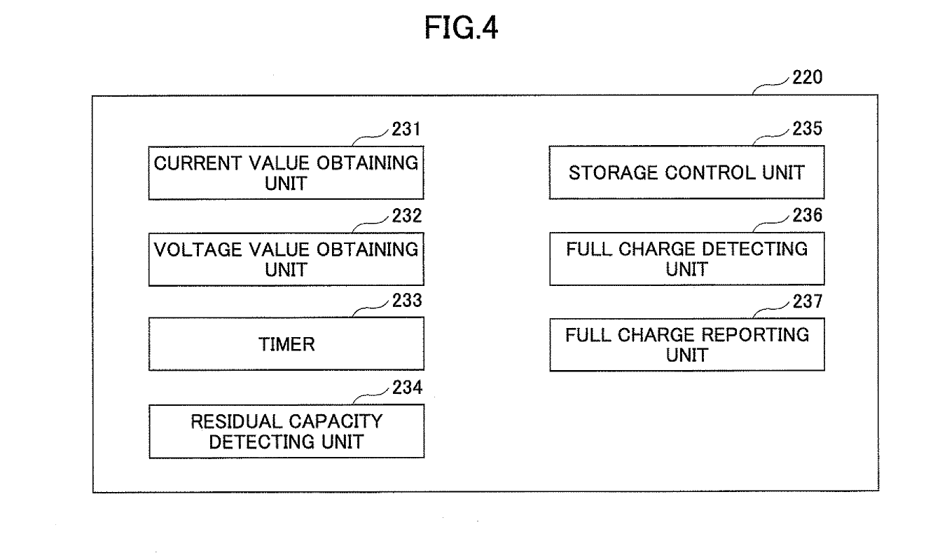

The monitoring IC 220 is explained in detail with reference to FIG. 3 and FIG. 4. FIG. 3 is a diagram showing a hardware structure of the monitoring IC. In FIG. 3, the monitoring IC 220 includes a Central Processing Unit (CPU) 221, a sensor unit 222, a Read Only Memory (ROM) 223, an Electrically Erasable and Programmable ROM (EEPROM) 224, and a serial interface (serial I/F) 225.

The CPU 221 controls units of the monitoring IC 220. The sensor unit 222 detects voltage, current, and temperature of the battery unit 210. The ROM 223 stores a program executed by the CPU 221 to control the units of the monitoring IC 220. The ROM 223 may be composed by a rewritable flash memory capable of rewriting the program in order to calculate a more specific residual capacity of the battery. The EEPROM 224 stores data such as parameters of the voltage, the current, and the temperature of the battery unit 210 detected by the sensor unit 222 and the like. The EEPROM 224 may store the program executed by the CPU 221 to control the units of the monitoring IC 220.

The serial I/F 225 communicates with the portable apparatus 100 via the communication terminal SIO. The CPU 221, the sensor unit 222, the ROM 223, the EEPROM 224 and the serial I/F 225 are connected with each other by a bus 226 and capable of sending and receiving data and programs to and from each other.

The sensor unit 222 includes a temperature sensor circuit 222a, a voltage sensor circuit 222b, a current sensor circuit 222c, a multiplexer 222d and an analog-digital (A/D) converter circuit 222e.

The temperature sensor circuit 222a detects temperature of the battery unit 210. The voltage sensor circuit 222b detects an output voltage of the battery unit 210 via the voltage detection terminal VBAT1 connected to the battery unit 210. The current sensor circuit 222c detects a current that flows through the external resistance R11, which is a charge and discharge current of the battery unit 210, via the current detection terminals VRSP and VRSM. Outputs of the temperature sensor circuit 222a, the voltage sensor circuit 222b and the current sensor circuit 222c are connected to the multiplexer 222d, and outputted as a single signal by the multiplexer 222d. The A/D converter circuit 222e converts the signal output by the multiplexer 222d from analog to digital.

FIG. 4 is an explanatory view showing a functional structure of the monitoring IC. In this embodiment, the functional structure of the monitoring IC 220 shown in FIG. 4 is actualized by a specific program stored in the ROM 223 shown in FIG. 3.

The monitoring IC 220 includes a current value obtaining unit 231, a voltage value obtaining unit 232, a timer 233, a residual capacity detecting unit 234, a storage control unit 235, a full charge detecting unit 236, and a full charge reporting unit 237.

The current value obtaining unit 231 obtains a current value detected by the current sensor circuit 222c. The voltage value obtaining unit 232 obtains a voltage value detected by the voltage sensor circuit 222b. The timer 233 counts time by a timer function contained in the monitoring IC 220.

The residual capacity detecting unit 234 detects a residual capacity of the battery unit 210 as residual capacity data by the current value obtained by the current value obtaining unit 231 or the voltage value obtained by the voltage value obtaining unit 232 and by the timer function of the timer 233.

The storage control unit 235 stores status information or the like such as the current value obtained by the current value obtaining unit 231, the voltage value obtained by the voltage value obtaining unit 232, the residual capacity detected by the residual capacity detecting unit 234 or the like in the EEPROM 224 or the like, for example.

The full charge detecting unit 236 detects a full charge of the secondary battery 211 composing the battery unit 210 based on the residual capacity data detected by the residual capacity detecting unit 234. The full charge detecting unit 236 of the embodiment may, for example, detect the full charge when the residual capacity data detected by the residual capacity detecting unit 234 becomes 100%.

When the full charge detecting unit 236 detects full charge, the full charge reporting unit 237 outputs a report signal reporting that the full charge is detected to be reported to the portable apparatus 100. The full charge reporting unit 237 of the embodiment may report status information such as the residual capacity data of the secondary battery 211 to the portable apparatus 100 in addition to the report signal reporting full charge.

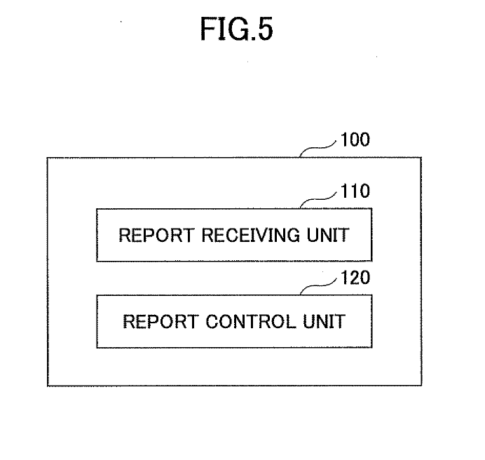

Next, a functional structure of the portable apparatus 100 according to the embodiment will be explained. FIG. 5 is an explanatory view showing a functional structure of the portable apparatus of the first embodiment.

The portable apparatus 100 of the embodiment includes a report receiving unit 110 and a report control unit 120. The report receiving unit 110 receives the report signal output from the monitoring IC 220 of the battery pack 200. The report control unit 120 reports the full charge to a user of the portable apparatus 100 when the report receiving unit 110 receives the report signal.

The report control unit 120 of the embodiment, for example, may have the display device 12 of the portable apparatus 100 display a message indicating that the charging is completed in order to report the completion of charging to the user and to recommend removing (shut-down) the charging adapter.

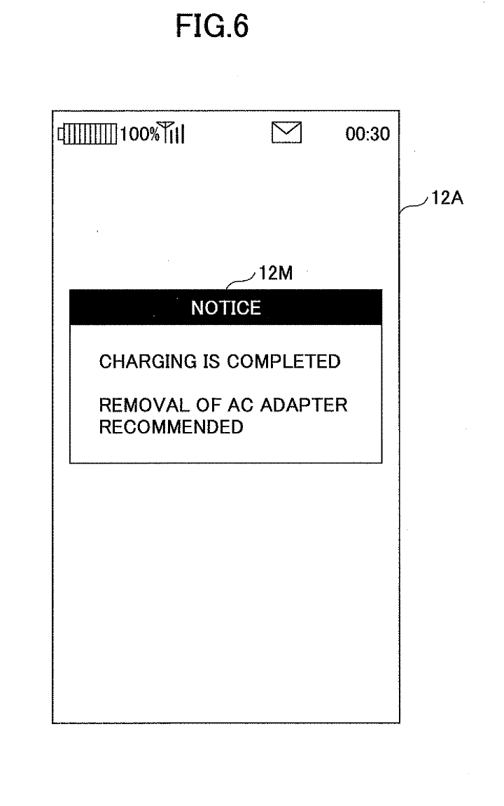

FIG. 6 is a drawing showing an example of a screen where a message indicating the completion of charging is shown. Arrows in FIG. 6 express a current path. In the screen 12A shown in FIG. 6, a message 12M recommending shutting of charging by the charging adapter is displayed. The portable apparatus 100 can report the completion of charging by the message 12M.

As described above, according to the present embodiment, the monitoring IC 220 in the battery pack 200 detects the full charge based on the residual capacity data of the battery unit 210. Therefore, in this embodiment, the time when the secondary battery 211 is fully charged is accurately detected based on the status of the secondary battery 211.

Further, according to the embodiment, when the full charge is detected by the monitoring IC 220, the monitoring IC 220 reports that the full charge is detected to the portable apparatus 100. Then, upon receiving the report, the portable apparatus 100 reports the completion of charging to the user. Therefore, according to the embodiment, it is possible to recommend termination of charging right after the secondary battery 211 is fully charged, and therefore deterioration of the secondary battery 211 can be suppressed.

Although the report control unit 120 of the embodiment reports the completion of charging to the user by displaying a message on the display device 12, it is not limited so.

For example, the portable apparatus 100 of the embodiment may include a light as a report unit that indicates under charging by lighting and indicates a completion of charging by extinguishing, and the report control unit 120 may control the lighting and extinguishing of the light to report the completion of charging to the user.

Further, the portable apparatus 100 of the embodiment may include a vibration generating unit that vibrates the apparatus body, and the report control unit 120 may control the vibration generating unit to report the completion of charging. For example, the report control unit 120 may control to generate a vibration by the vibration generating unit when the report receiving unit 110 receives the report.

The portable apparatus 100 of the embodiment may include a sound outputting unit, and the report control unit 120 may output a report sound by the sound outputting unit when the report receiving unit 110 receives the report.

### Second Embodiment

The second embodiment will be explained with reference to drawings. For the second embodiment, charging is terminated when a signal reporting the full charge received is different from the first embodiment. In the explanation of the following second embodiment, only points different from the first embodiment are explained, and the components having the same functional structure as the first embodiment are given the same reference numerals and explanations are not repeated.

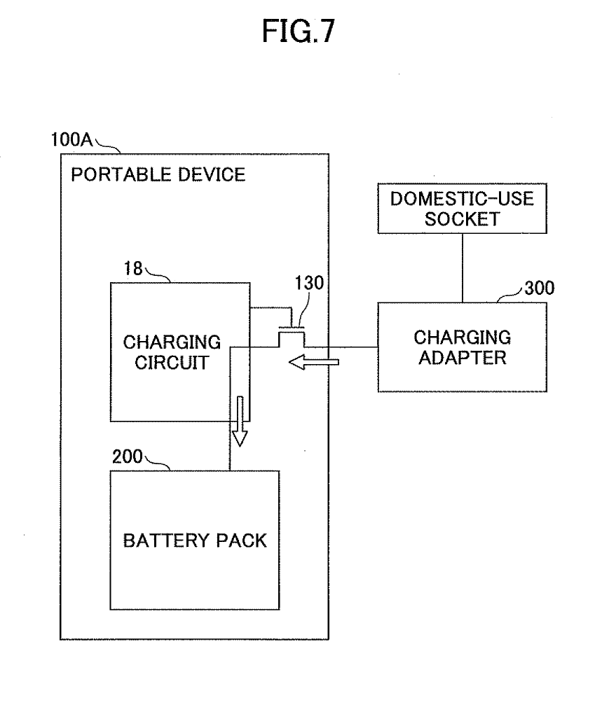

FIG. 7 is an explanatory view showing a portable apparatus of the second embodiment

The portable apparatus 100A of the embodiment includes a charging circuit 18 between the charging adapter 300 and the battery pack 200. The charging adapter 300 supplies a voltage supplied from a domestic-use socket to the portable apparatus 100A of the embodiment. The charging circuit 18 controls the voltage supplied from the charging adapter 300 to be a voltage appropriate for the battery pack 200 to supply the battery pack 200.

In this embodiment, a switch device 130 that controls the connection between the charging adapter 300 and the battery pack 200 is provided at a path connecting the charging adapter 300 and the battery pack 200. When the portable apparatus 100A of the embodiment receives the report that the full charge is detected from the battery pack 200, the portable apparatus 100A switches off the switch device 130 by the charging circuit 18 to shut down the connection between the charging adapter 300 and the battery pack 200.

In this embodiment, with this structure, it is possible to shut off charging to the secondary battery 211 right after the monitoring IC 220 detects full charge. Therefore, according to the present embodiment, deterioration of the secondary battery by charging can be suppressed.

As described above, in an embodiment, there is provided a battery pack (200) including a secondary battery (211) chargeable and dischargeable and providing a power from the secondary battery (211) to an apparatus body (100) that contains the battery pack (200), including, a residual capacity detecting unit (234) that detects a residual capacity of the secondary battery (211); a full charge detecting unit (236) that detects a full charge of the secondary battery (211) based on the residual capacity; and a full charge reporting unit (237) that reports that the full charge is detected to the apparatus body (100).

In an embodiment, there is provided a portable apparatus (100) containing a battery pack (200) that includes a secondary battery (211) chargeable and dischargeable, a residual capacity detecting unit (234) that detects a residual capacity of the secondary battery (211), a full charge detecting unit (236) that detects a full charge of the secondary battery (211) based on the residual capacity, and a full charge reporting unit (237) that reports that the full charge is detected to the portable apparatus (100), and being driven by a power provided by the secondary battery (211), including, a report receiving unit (110) that receives a report indicating that the full charge of the secondary battery is detected from the battery pack; and a report control unit (120) that reports that the secondary battery (211) is fully charged to a user of the portable apparatus (100) when the report receiving unit (110) receives the report.

In the portable apparatus of the embodiment, the report control unit (120) may have a display unit (12) of the portable apparatus (100) display a message reporting that the secondary battery (211) is fully charged.

In the portable apparatus of the embodiment, the portable apparatus may further include a vibration generating unit that vibrates the portable apparatus (100), and the report control unit (120) may have the vibration generating unit generate vibration when the report receiving unit (110) receives the report.

In the portable apparatus of the embodiment, the report control unit (120) may have a sound outputting unit of the portable apparatus (100) output a report sound when the report receiving unit (110) receives the report.

In an embodiment, there is provided a method of reporting the full charge by a portable apparatus (100) containing a battery pack (200) including a secondary battery (211) chargeable and dischargeable, and being driven by a power provided by the secondary battery (211), including, having the battery pack (200) perform a residual capacity detecting step of detecting a residual capacity of the secondary battery (211), a full charge detecting step of detecting a full charge of the secondary battery (211) based on the residual capacity, and a full charge reporting step of reporting that the full charge is detected to the portable apparatus (100); and having the portable apparatus (100) perform a report receiving step of receiving the report from the battery pack (200), and a report control step of reporting that the secondary battery (211) is fully charged to a user of the portable apparatus (100) when receiving the report.

In an embodiment, there is provided a computer readable recording medium having recorded thereon a program that causes a portable apparatus (100) containing a battery pack (200) including a secondary battery (211) chargeable and dischargeable, and being driven by a power provided by the secondary battery (211) to execute a method of reporting full charge, the method including, having the battery pack (200) perform a residual capacity detecting step of detecting a residual capacity of the secondary battery (211), a full charge detecting step of detecting a full charge of the secondary battery (211) based on the residual capacity, and a full charge reporting step of reporting that the full charge is detected to the portable apparatus (100); and having the portable apparatus (100) perform a report receiving step of receiving the report from the battery pack (200), and a report control step of reporting that the secondary battery (211) is fully charged to a user of the portable apparatus (100) when receiving the report.

In an embodiment, there is provided a semiconductor device (220) mounted on a battery pack (200) including a secondary battery (211) chargeable and dischargeable and providing a power from the secondary battery (211) to an apparatus body that contains the battery pack (200), including, a residual capacity detecting unit (234) that detects a residual capacity of the secondary battery (211); a full charge detecting unit (236) that detects a full charge of the secondary battery (211) based on the residual capacity; and a full charge reporting unit (237) that reports that the full charge is detected to the apparatus body (100).

The above numerals in brackets are just shown for explanatory purposes and are just an example and not limited to the embodiments shown in the drawings.

As described above, the present invention is described with embodiments thereof, however, the present invention is not limited to the disclosed embodiments, and variations and modifications may be made without departing from the scope of the present invention. The present application is based on Japanese

Priority Application No. 2009-162422 filed on Jul. 9, 2009, the entire contents of which are hereby incorporated herein by reference.

What is claimed is:

1. A battery pack including a secondary battery chargeable and dischargeable and providing a power from the secondary battery to an apparatus body that contains the battery pack, comprising:
a residual capacity detecting unit that detects a residual capacity of the secondary battery;
a full charge detecting unit that detects a full charge of the secondary battery based on the residual capacity; and
a full charge reporting unit that reports that the full charge is detected to the apparatus body.

2. A portable apparatus containing a battery pack that includes a secondary battery chargeable and dischargeable, a residual capacity detecting unit that detects a residual capacity of the secondary battery, a full charge detecting unit that detects a full charge of the secondary battery based on the residual capacity, and a full charge reporting unit that reports that the full charge is detected to the portable apparatus, and being driven by a power provided by the secondary battery, comprising:
a report receiving unit that receives a report indicating that the full charge of the secondary battery is detected from the battery pack; and
a report control unit that reports that the secondary battery is fully charged to a user of the portable apparatus when the report receiving unit receives the report.

3. The portable apparatus according to claim 2, wherein the report control unit has a display unit of the portable apparatus display a message reporting that the secondary battery is fully charged.

4. The portable apparatus according to claim 2, further comprising a vibration generating unit that vibrates the portable apparatus,
wherein the report control unit has the vibration generating unit generate vibration when the report receiving unit receives the report.

5. The portable apparatus according to claim 2, wherein the report control unit has a sound outputting unit of the portable apparatus output a report sound when the report receiving unit receives the report.

6. A method of reporting full charge by a portable apparatus containing a battery pack including a secondary battery chargeable and dischargeable, and being driven by a power provided by the secondary battery, comprising:
having the battery pack perform
a residual capacity detecting step of detecting a residual capacity of the secondary battery,
a full charge detecting step of detecting a full charge of the secondary battery based on the residual capacity, and
a full charge reporting step of reporting that the full charge is detected to the portable apparatus; and
having the portable apparatus perform
a report receiving step of receiving the report from the battery pack, and
a report control step of reporting that the secondary battery is fully charged to a user of the portable apparatus when receiving the report.

7. A computer readable recording medium having recorded thereon a program that causes a portable apparatus containing a battery pack including a secondary battery chargeable and dischargeable, and being driven by a power provided by the secondary battery to execute a method of reporting full charge, the method comprising:
having the battery pack perform
a residual capacity detecting step of detecting a residual capacity of the secondary battery,
a full charge detecting step of detecting a full charge of the secondary battery based on the residual capacity, and
a full charge reporting step of reporting that the full charge is detected to the portable apparatus; and
having the portable apparatus perform
a report receiving step of receiving a report that indicates the secondary battery is fully charged from the battery pack, and
a report control step of reporting that the secondary battery is fully charged to a user of the portable apparatus when receiving the report.

8. A semiconductor device mounted on a battery pack including a secondary battery chargeable and dischargeable and providing a power from the secondary battery to an apparatus body that contains the battery pack, comprising:
a residual capacity detecting unit that detects a residual capacity of the secondary battery;
a full charge detecting unit that detects a full charge of the secondary battery based on the residual capacity; and
a full charge reporting unit that reports that the full charge is detected to the apparatus body.
